(19) United States
(12) Patent Application Publication
(10) Pub. No.: US 2011/0052296 A1
(43) Pub. Date: Mar. 3, 2011

(54) KEYBOARD

(76) Inventor: Toshiyasu Abe, Bellevue, WA (US)

(21) Appl. No.: 12/550,267

(22) Filed: Aug. 28, 2009

(51) Int. Cl. B41J 5/00

(52) U.S. Cl. 400/484; 400/485; 400/489

(57) ABSTRACT

A keyboard having an arrangement of English letters and Japanese Kana (Hiragana) characters across keys of the keyboard. The keys are associated with more than two letters and/or characters. The key arrangements facilitate easier memorization. In one embodiment, an example keyboard includes a 6 key arrangement (3 keys in a top row and 3 keys in a lower row). This arrangement is useful for cellular phones and other small computing devices.

### BACKGROUND OF THE INVENTION

The Japanese alphabet is arranged as follows:

| | | | | |
|---|---|---|---|---|
| A = [symbol] | I = [symbol] | U = [symbol] | E = [symbol] | O = [symbol] |
| KA = [symbol] | KI = [symbol] | KU = [symbol] | KE = [symbol] | KO = [symbol] |
| SA = [symbol] | SI = [symbol] | SU = [symbol] | SE = [symbol] | SO = [symbol] |
| TA = [symbol] | TI = [symbol] | TU = [symbol] | TE = [symbol] | TO = [symbol] |
| NA = [symbol] | NI = [symbol] | NU = [symbol] | NE = [symbol] | NO = [symbol] |
| HA = [symbol] | HI = [symbol] | HU = [symbol] | HE = [symbol] | HO = [symbol] |
| MA = [symbol] | MI = [symbol] | MU = [symbol] | ME = [symbol] | MO = [symbol] |
| YA = [symbol] | — | YU = [symbol] | — | YO = [symbol] |
| RA = [symbol] | RI = [symbol] | RU = [symbol] | RE = [symbol] | RO = [symbol] |
| WA = [symbol] | — | — | — | WO = [symbol] |

The Japanese alphabet is read from top left to top right and continue down (by rows).

Five vowels A, I, U, E, O come first and then consonants K, S, T, N, H, M, Y, R, W are added before vowels to make the other characters. Blank areas, indicated by (−), exist because there are no characters for these sounds or another character sounds the same so there is no need to repeat.

There are more characters other than this list but its arrangement is very orderly using vowels as a sequence base whereas English alphabet is arranged rather randomly.

Because of this vowel base arrangement, Japanese keypads for cellular phones and other small devices, which have less keys than a full size keyboard, use the above arrangement. For example, push the “A” key once for letter “A”, push the “A” key twice for “I”, push the “A” key three times for “U”, push the “A” key four times for “E”, push the “A” key five times for “O”. To get “KA” another key is activated once. The same other key is activated twice for “KI”, three times for “KU” and so on. Five of all vowels are confined within the same key and different consonants are assigned to other keys. Or, vowels confined and consonants spread out arrangement.

Thus, the present key configurations fail to facilitate users to grasp the structure of the whole arrangement thus making it more difficult to memorize and remember. Also, because the Japanese vowels are not arranged in similar locations as vowels in another language (e.g., English), then one who enters text in both languages must memorize two different sets of key arrangements.

### SUMMARY OF THE INVENTION

The present invention provides various arrangements of English letters and Japanese Kana (Hiragana) characters across keys of keyboard, where the keys are associated with more than two letters and/or characters. The key arrangements of the present invention facilitate easier memorization. This arrangement can be used by one's thumb, hand or both hands.

In one aspect of the invention, an example includes a 6 key arrangement (3 keys in a top row and 3 keys in a lower row). This arrangement is useful for cellular phones and other small computing devices.

### BRIEF DESCRIPTION OF THE DRAWINGS

The preferred embodiment of the present invention is described in detail below with reference to the following drawings:

FIG. 1 is a block diagram of the components of the present invention;

FIGS. 2A-C are flow diagrams performed by the components of FIG. 1;

FIG. 3 is a top view of a single-handed embodiment of the present invention;

FIGS. 4 and 5 are top views of a two-handed embodiment of the present invention;

FIG. 6 is an x-ray top view of a single keypad formed in accordance with the present invention;

FIGS. 7A and B are cross-sectional views of the keypad shown in FIG. 6;

FIG. 8 illustrates a Japanese version of the present invention;

FIGS. 9A-C illustrate selectable Japanese alphabetic characters according to multiple key selections;

FIGS. 10A-B illustrate a top view of a two-handed keyboard with thumb controllers;

FIGS. 11-15 illustrate the present implemented in various devices;

FIGS. 16A-F illustrate various functions assigned to different key motions; and

FIGS. 17-20 illustrate various English and associated Hiragana keyboard layouts.

### DETAILED DESCRIPTION OF THE PREFERRED EMBODIMENT

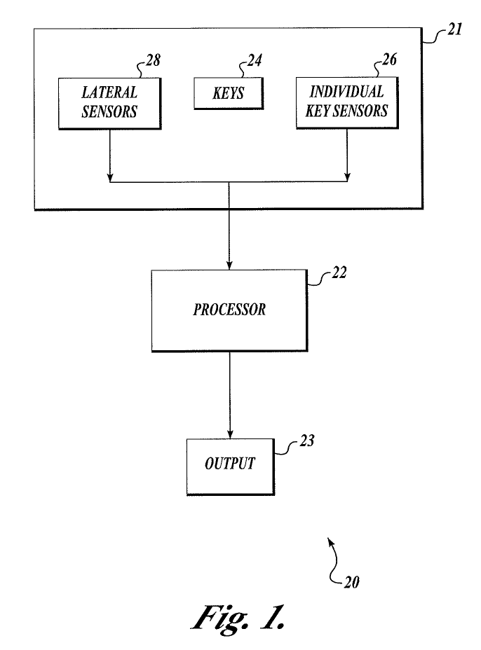

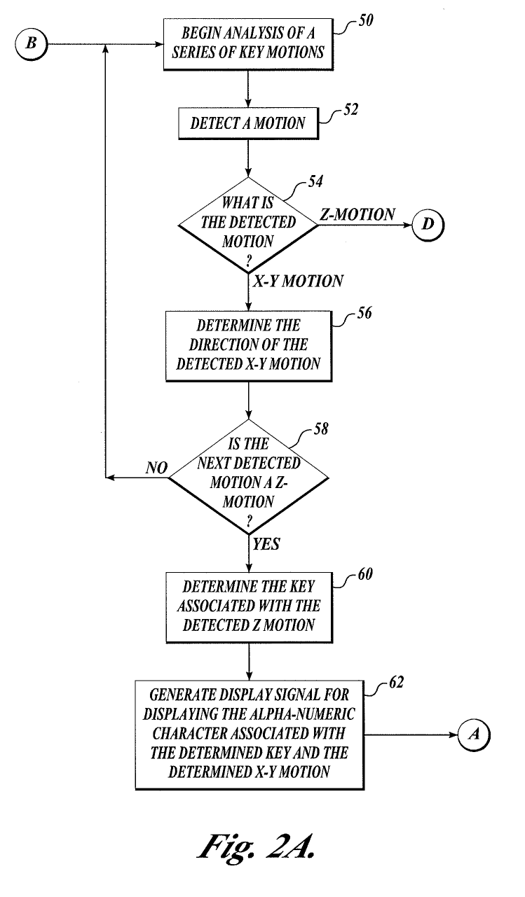

FIG. 1 illustrates components of a keyboard system 20 formed in accordance with the present invention. The keyboard system 20 includes a keyboard 21 connected to a processor 22. The processor 22 is connected to an output 23. The output 23 is preferably a display device. The keyboard 21 includes a plurality of keys 24, individual key sensors 26 and a set of lateral sensors 28. When a user depresses a key, the individual key sensors 26 generate a key select signal that indicates which key has been selected. When the keys 24 are moved laterally, the lateral sensors 28 generate a lateral signal that indicates the direction of motion. The generated signals are sent to the processor 22 for analysis. The processor 22 generates an output signal for directing operation of the output 23 based upon the analysis.

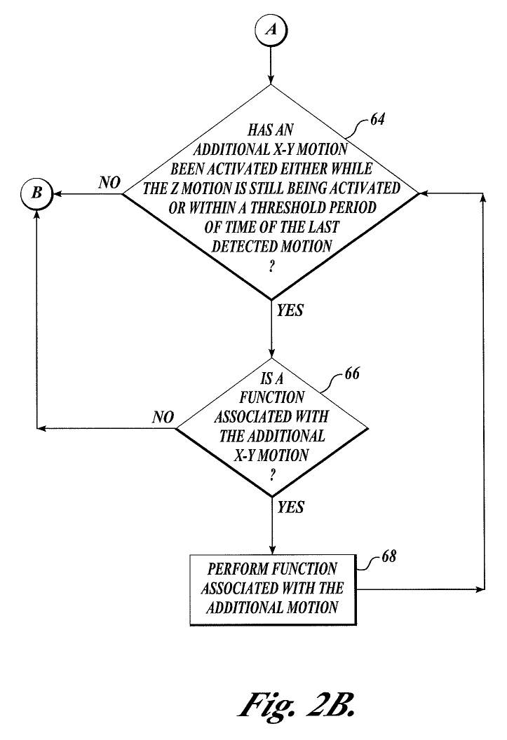

FIGS. 2A-2C illustrate a process performed by the keyboard system shown in FIG. 1. First, at block 50, detection of one or more of key motions begins. At block 52, a first key motion in a series of key motions is detected. Next, at decision block 54, the process determines characteristics of the motion based on the signals generated and sent from the sensors 26, 28. The characteristics of motions that are detected are either an X-Y motion (a lateral motion or a motion approximately parallel to the keyboard plane), or a Z motion (a key depression motion or a motion in a direction generally perpendicular to the keyboard plane). As will be discussed further below, the “motion” detected need not literally comprise key movement, but could alternatively amount to the detection of forces that do not actually move the keys. In such an embodiment, the method evaluates the force imparted on the keys to ascertain force vectors in lateral and vertical planes. Though the following discussion describes motion, all motions could alternatively be detected forces. If the first detected motion (or force) in a series of motions is an X-Y motion, the processor determines the direction of the detected X-Y motion according to the received lateral sensor signal, see block 56. Next, at decision block 58, the process determines if the next detected motion is a Z motion. If the next detected motion is not a Z motion but is another X-Y motion, the process concludes that an error has occurred and returns to block 50 for analyzing a new series of key motions. If, at decision block 58, the detected motion is a Z motion, the process determines the location of the motion and therefore which key is associated with the detected Z motion, see block 60. Next, at block 62, the process generates a display signal for displaying the character or symbol that is associated with the determined key and the determined X-Y motion direction. Next, at decision block 64, the process determines if an additional X-Y motion has been applied while the Z motion is still activated or within a threshold period of time since the Z motion. If no additional X-Y motions have been detected, the process returns to block 50 for processing of a next series of key motions. If an additional X-Y motion has been applied, the process determines if a function is associated with the additional X-Y motion, see decision block 66. If a function is associated with the additional X-Y motion, the process performs the function or action associated with the additional motion, see block 68, and the process returns to decision block 64 for determining if any further X-Y motions have occurred or are occurring. If no function is associated with additional X-Y motion, the process returns to block 50.

In some embodiments, individual keys serve as function keys in addition to representing characters. While characters are typically selected by a motion (or force) in the X-Y and Z planes, functions can be selected by a downward motion alone. Thus, if the defected motion is a downward one, the invention determines, whether a function has been selected. Returning to decision block 54 in FIG. 2A, if the initial detected motion is a Z motion (or force), the process continues to D at the top of FIG. 2C. If the detected motion is a Z motion, the process determines the key(s) associated with the detected Z motion, see block 72. Then, at decision block 74, the process determines whether there is a function associated with the determined key(s). In this sense, a “function” may include, for example, if there is no function associated with the determined key(s), the process returns to block 50 for processing of a next series of key motions. However, if a function is associated with the determined key(s), the process determines if the associated function requires the X-Y motion to perform a component of the associated function, see decision block 76. If no X-Y motion is determined to be required, the process performs the associated function, see block 78. After block 78, the process returns to block 50. If the associated function requires an X-Y motion to perform a component thereof, the process determines whether an X-Y motion has been detected, see block 80. After the X-Y motion has been detected, the process performs the component function associated with the detected X-Y motion, see block 82. Next, at decision block 84, the process determines if an additional X-Y motion has been applied within a threshold period of time since the last detected X-Y motion. If the determination of decision block 84 has not been met, the process returns to block 50. If an additional X-Y motion has been applied within the threshold period of time since the last detected X-Y motion, the processor determines if the component function has any associated subcomponent functions, see decision block 86. If no associated subcomponent functions are associated with the additional X-Y motion, the process returns to block 50. If a subcomponent function is associated with the additional X-Y motion, the process performs the associated subcomponent function, see block 88, then the process returns to decision block 84.

The above description assumes that no X-Y component will be detected when a user selects a function that only requires a downward keystroke, of course, slight lateral forces will almost always be detected even if the user tries to press downward only. Consequently, a threshold amount of lateral movement (or force) is required to be detected before the method determines that a lateral movement was intended.

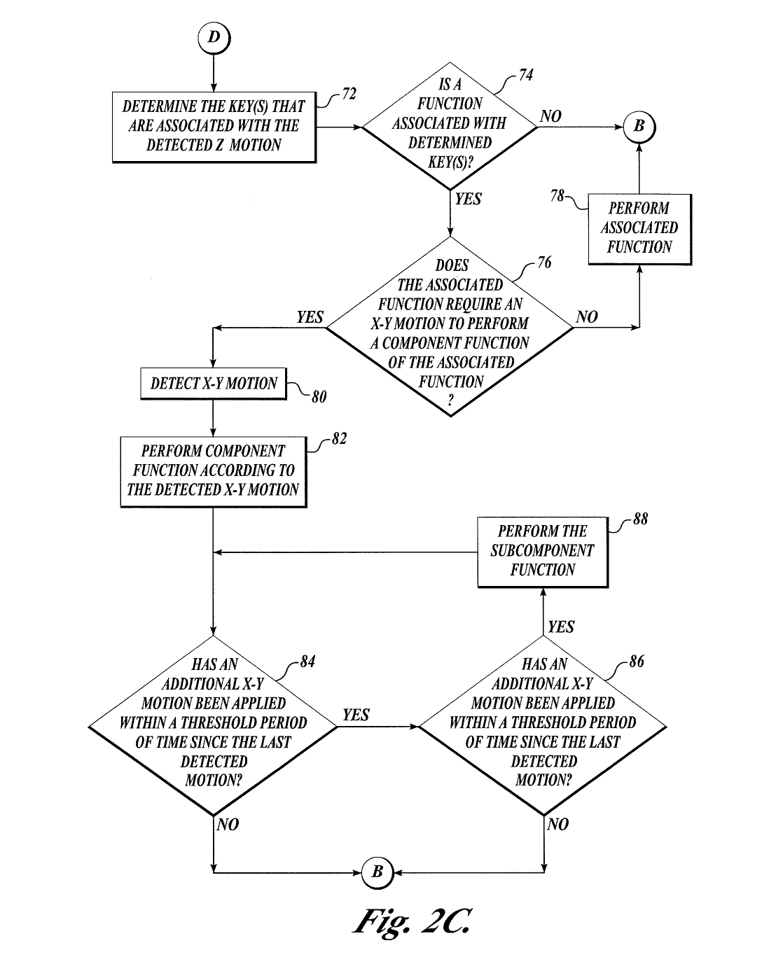

FIG. 3 illustrates an example keypad for performing the process described for FIGS. 2A-C above. FIG. 3 illustrates a single-handed embodiment of the present invention. Although the keypad of FIG. 3 is operable by a single-hand, it is possible to use both hands to operate it. FIG. 3 illustrates a keypad 130 with a plurality of hexagonal shaped keys 132a-g. The keys 132a-c and 132e-g are positioned around and adjacent to a center key 132d. The keys 132a-g reside in a keypad well 136. The well 136 is wider than the diameter of the group of keys 132a-g. The well 136 allows movement of the keys 132a-g laterally within the well 136. Displayed next to each of the sides on each key is a number, a letter, a symbol or a function name. For example, on the left vertical edge of key 132a is an asterisk symbol, and on the right vertical edge is the number 3. Each item displayed on the keys is selected or activated by a user in a first mode of keyboard operation. In a second mode of keyboard operation, a group of items (symbols, numbers, characters, or functions) not shown on the keys are selectable by the user. In still another embodiment, some or all of the entire group of items (symbols, numbers, characters, or functions) selectable in a second mode of keyboard operation are displayed in the keys in a different font or color than the group of items (symbols, numbers, characters, or functions) associated with the first mode of keyboard operation. At decision block 54 of FIG. 2A the mode selection occurs. If the first motion is an X-Y motion, the mode is the first mode and if the first motion is a Z motion, the mode is the second mode.

Virtually any function is assignable to the keys of the present invention in the first or second mode of operation. Examples of functions that are assignable to key motions are illustrated below in FIGS. 16A-F.

The present invention can be of any size for implementation into any device that requires some form of user interface. Some examples of which are described below with reference to FIGS. 11-15. The keys may be implemented in shapes other than hexagons, such as shapes with more or fewer sides, or circles. With keys that are circular, directional motion sensing is performed within certain ranges of degrees around the circle.

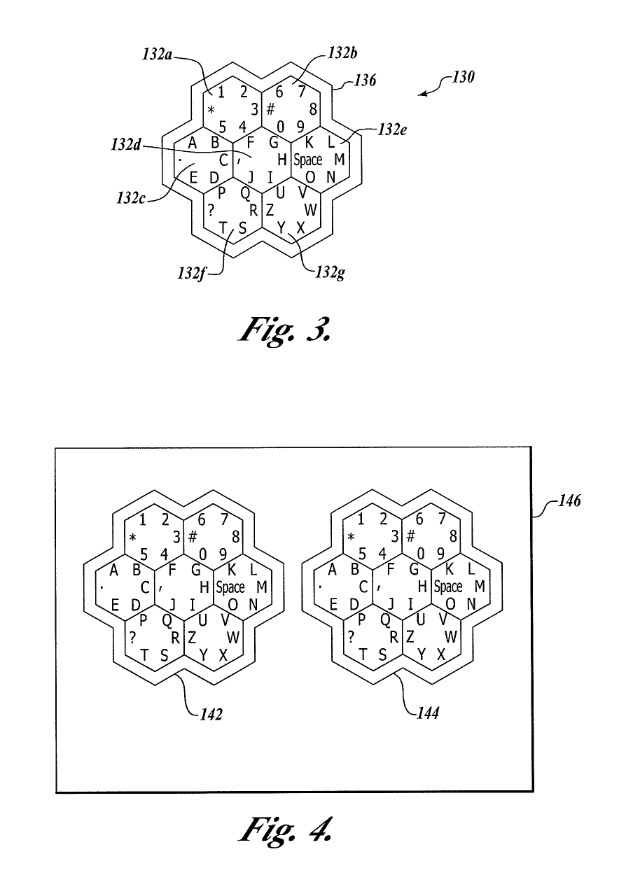

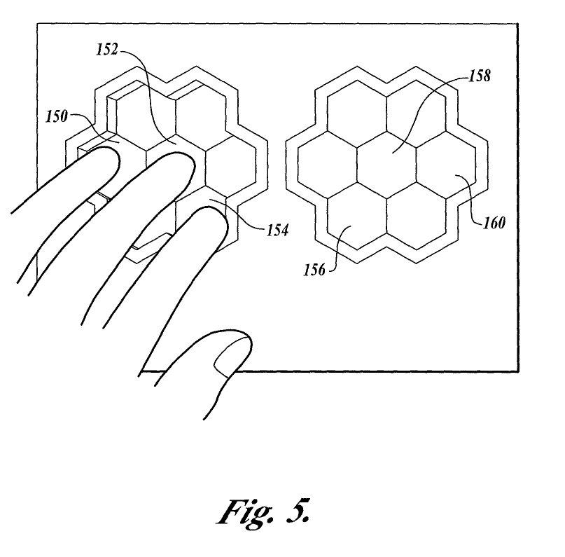

FIG. 4 illustrates a keyboard 146 that includes two identical sets of seven hexagon keys 142, 144. This keyboard layout is usable in a single-handed mode or a two-handed mode. In an alternate embodiment the sets of keys 142, 144 are not identical. As shown in FIG. 5, the users place their left hand on the left set of keys 142 and their right hand on the right set of keys 144. The users' ring finger on both their left and right hands are placed on the outermost middle keys 150, 160 of the respective sets of keys. The middle fingers are preferably placed on the middle key 152, 158 respectively of each set of keys 142, 144 and the forefingers are placed on the innermost bottom keys 154, 156 respectively. When users operate this two-handed keyboard 146 as described above, six fingers are in contact with keys associated with all the letters of the alphabet, and can select all of the letters without lifting any fingers. When the keyboard is operated as described above the user's hands rest in a natural position, thereby not producing finger fatigue associated with typing.

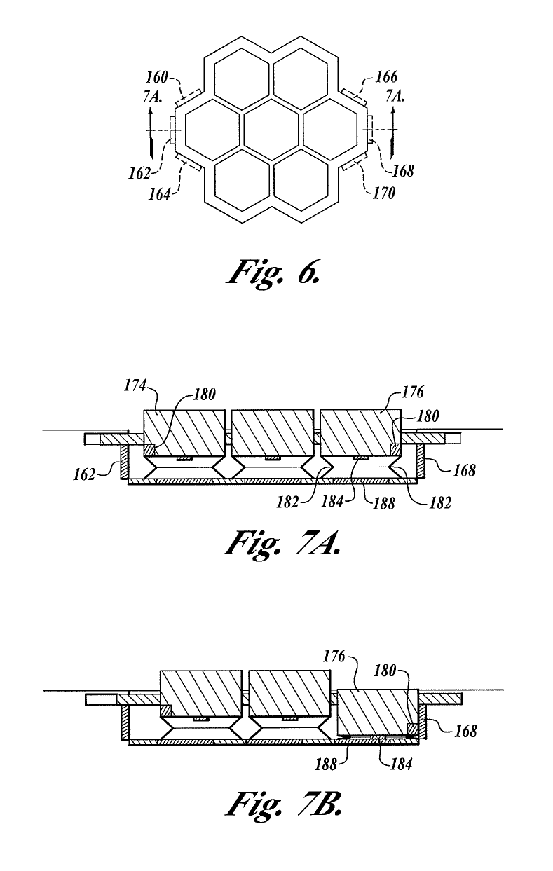

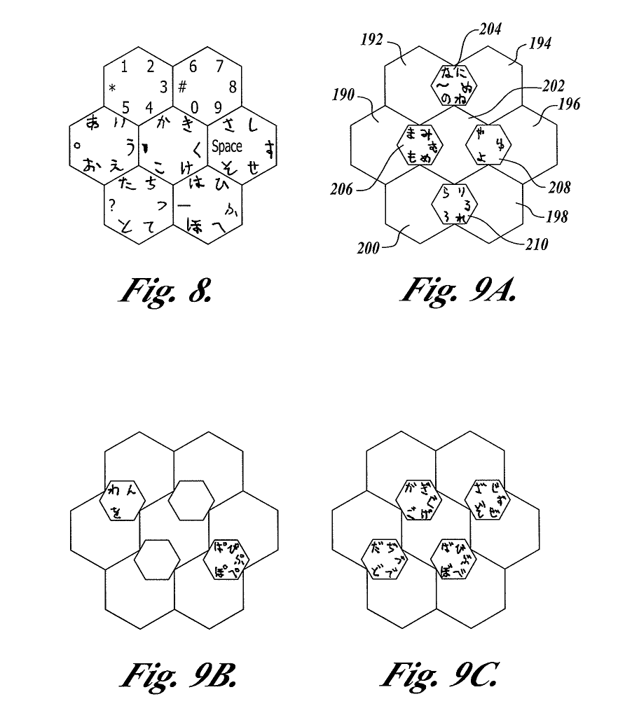

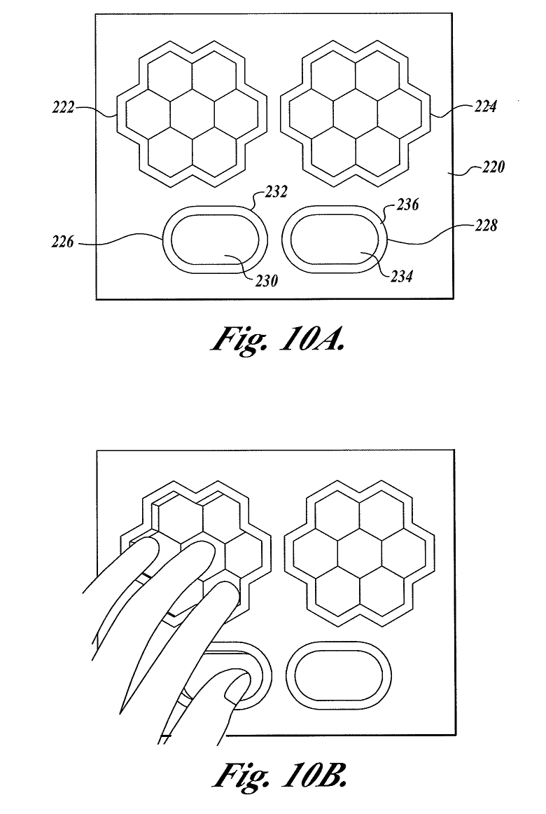

FIGS. 6, 7A and 7B illustrate the various sensors and mechanisms that enable a user to cause the set of keys to generate desired signals for either displaying characters or executing functions assigned to the keys. FIG. 6 is a plan view of a keypad 159. Since in this example each of the keys is hexagonal shaped and actions are assigned to each side of each key, the keypad requires mechanisms for sensing when the user moves the keys in one of the six directions. A direction is generally orthogonal to a side. In the embodiment shown in FIG. 6, the keys move as one unit within a cavity 171. Located within the cavity 171 are lateral sensors 161-170. The sensors 161-170 are located at all the possible directional sides that the keys can move. In this example, the edges of the cavity 171 closest to the outside three edges of both the left and right-most keys of the set of keys 159 include the lateral sensors 161-170. Alternatively, the sensors can be placed near any of the other keys provided that they sense all six directional movements of the plurality of keys 159. Moreover, only three sensors are required because each of the sensors 161, 162, 164 detects motion in the opposite direction as corresponding sensors 166, 168, 170. So long as three sensors are able to detect motion (or force) in both directions, three sensors are sufficient for the preferred hexagonal key embodiment.

FIGS. 7A and B are cross sectional views of the keypad shown in FIG. 6. The keys reside in the cavity 171 and each key is supported by a spring like support 182 that allows each key to move both vertically and horizontally within the cavity 171. Located at the base of each key is a sensor 184. Underneath each key on the cavity's base or within the cavity's base are a plurality of sensors 188 that sense when the key mounted sensor 184 contacts the sensor 188 or comes within a threshold distance, thereby generating a signal that indicates that the key has been depressed, as shown in FIG. 7B. The sensor 188 is wider than the key sensor 184 in order to compensate for when the key is slid in a lateral direction while being depressed. Located at the base and side of the keys closest to the lateral sensors 161-170 are sensors 180. The lateral sensors 161-170 sense and generate a signal in a similar manner as to that of sensor 188 when the key sensor 180 contacts a lateral sensor or comes within a threshold distance for activating a lateral signal. Also shown in FIG. 7B, the keys move laterally as one unit while each key is individually depressible. As an alternative, the keys may be depressible as a group. Because a greater force will be detected beneath the depressed key, in this embodiment the processor receives information from all downward force sensors and determines which key was depressed. Various types of sensing mechanisms can be used to detect key motion and depression. Conventional mouse buttons or optical systems can alternately be used to identify when motion occurs. Also, the spring like devices 182 may be replaced on pedestals for each key or a single pedestal for the entire set of keys for allowing motion both laterally and vertically.

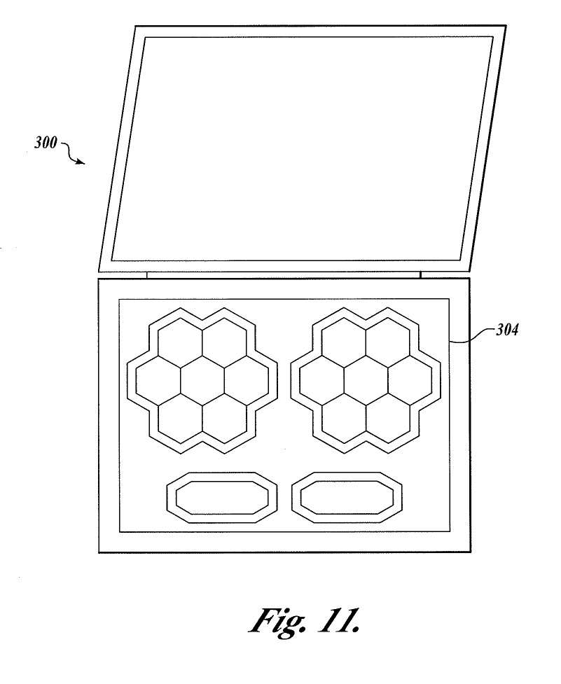

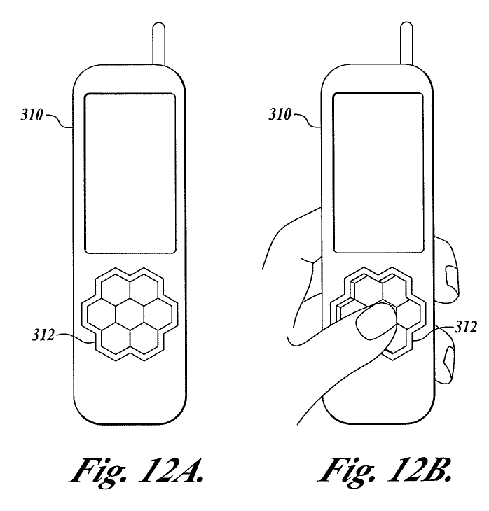

FIG. 8 illustrates a keypad, similar to the keys shown in FIG. 6, that includes Japanese alphabet characters instead of English alphabet characters. Other languages can also be implemented on the keyboard of the present invention. Since Japanese has many more alphabet characters, a greater number of characters are required on the input device in order to be effective. Therefore, there must be an ability to access more characters in order to adequately use this keyboard when modified to the Japanese language or other languages with a large amount of alphabet characters. In one embodiment, extra symbols are associated with key actions performed in the second mode of operation. FIGS. 9A-C illustrate a method for retrieving symbols not associated with the first or second mode of operation.

FIG. 9A illustrates additional character selections that are retrieved by the selection of two or more keys 190-202. If the keypad shown in FIG. 9A is a physical keypad, the keys 190-202 include assigned characters, such as shown in FIG. 8. Hexagon shapes 204-210 include additional characters and symbols. The hexagon shapes 204-210 are not shown on the keys, but are associated in memory with the keys 190-202 that they are shown here overlaying. In other words, when the underlying keys are substantially simultaneously depressed, either before or after lateral movement of the keys, one of the characters or symbols associated with the overlying shape is selected based on the direction of the lateral motion of the keys. For example, if keys 190-202 are moved in the 3:00 direction and the keys 192 and 194 are simultaneously depressed, the character selected for display is the character in the 3:00 position of the hexagon shape 204.

Other hexagon shapes 206-210 are associated with other sets of two key selections. FIGS. 9B and 9C illustrate other hexagon shapes that include additional characters or symbols; these other hexagon shapes are associated with activation of other pairs of keys. Also, characters and symbols are selectable from activation of more than two keys.

The present invention can also be implemented in a nonphysical keyboard mode (i.e. a virtual keyboard). For example, the keypad is implemented on a display screen, such as shown in FIG. 15 below. When implemented on a display screen or a touch display screen, the symbols (including numbers), characters or functions associated with key operation in the second mode or symbols, characters or functions associated with simultaneously selecting a plurality of keys, such as that shown in FIGS. 9A-C, are displayable on the display.

In the embodiment such as shown in FIG. 15 (or a similar embodiment in which the “keypad” is an overlay on a touch—sensitive device such as is commonly used for a computer pointer), the invention detects forces imparted on the keyboard. Because the keyboard in this embodiment does not move, each force is analyzed for a downward location component (to determine which key was selected) and a directional component (to determine the character on the key that is selected). In this fashion, the sliding strokes using a pointer, pen, stylus, or finger selects characters and functions as described above, though the keypad itself remains stationary.

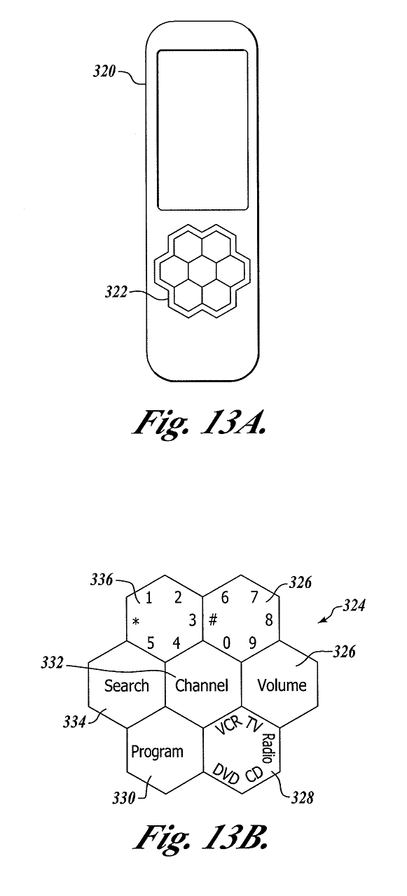

FIGS. 10A and 10B illustrate a two-handed keyboard 220 that includes thumb controllers 226, 228 that are used to aid in user operation of left and right keypads 222, 224 located on the keyboard 220. Each of the thumb controllers 226, 228 includes a thumb pad 230, 234 that resides in a cavity 232, 236. Each thumb pad 230, 234 moves in the X and Y directions within the respective cavity 232, 236. Each thumb pad is tied directly to the above associated set of keys. For example, if the user wants to move the plurality of left keys in the 3:00 direction, the user may either move the keypad 222 with their fingers in the 3:00 direction, move the thumb pad 230 below the left keypad in the 3:00 direction, or move both the thumb pad and the keypad 222 in the 3:00 direction. In an alternate embodiment, the thumb pad is the device that indicates directional motion for the keypad and the keypad is a stationary set of keys that only allow individual selection of the keys. In still another embodiment, the keyboard includes one thumb controller that is used for indicating lateral X-Y motion for one or both of the keypads 222, 224. The thumb pads can also be configured to move in the Z direction for performing other preassigned tasks.

FIG. 11 illustrates the keypad 220 implemented on a laptop computer device 300. Though shown on a laptop, it operates as described in the other embodiments or handheld Computer-OEM.

FIGS. 12A and 12B illustrate a cellular phone device 310 that includes a single keypad 312 similar to the keypad shown in FIG. 3. The keypad 312 is preferably located below a display area 314. The assignment of characters, symbols and functions to the keypad 312 is based on what characters, symbols, and functions are needed for effective user interaction with the cellular phone device 310.

FIG. 13A illustrates a remote control device 320 that includes a keypad 322, a close-up of which is shown in FIG. 13B. The keypad 322 is located below a display area 323. As shown in FIG. 13B, the keys are assigned numbers on keys 326, 336 and device control functions on keys 327-334 for the first mode of operation. If the user desires to increase the volume, the user moves the keypad in the one of six directions on the Volume key 327 that is assigned to generating a volume increase signal and depresses the Volume key 327. In this embodiment and other embodiments, the first mode of operation has a possible 7 keys×6 sides per key=42 places to assign a feature/command. Therefore, if the device in which the present invention is implemented does not require the generation of more than 42 command signals (these include number/character/symbol selection or operational function), then there is no a need to have a first and second mode of operation as described above. Thus, the step performed at decision block 54 of FIG. 2A is not performed. It does not matter what the first motion in a series of motions is. So, in the example above, the volume can be increased by first depressing the Volume key 327, then moving the keypad in the one of six directions on the Volume key 327 that is assigned to generating a volume increase signal or by moving the keypad laterally and then depressing the volume key.

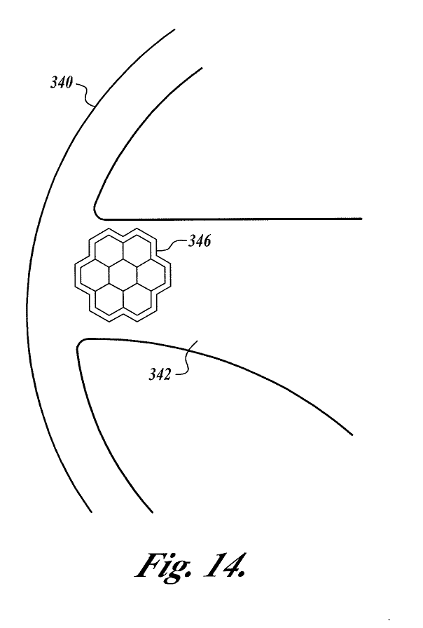

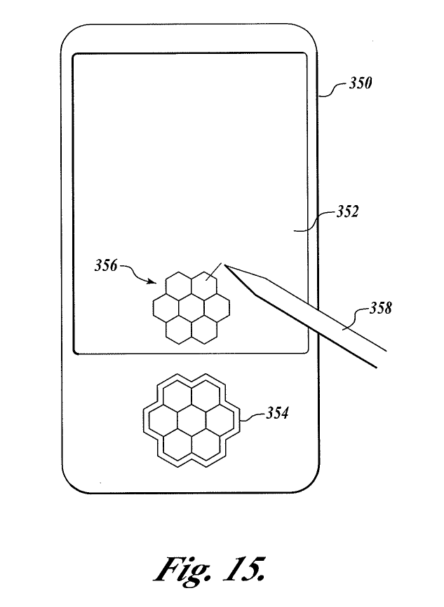

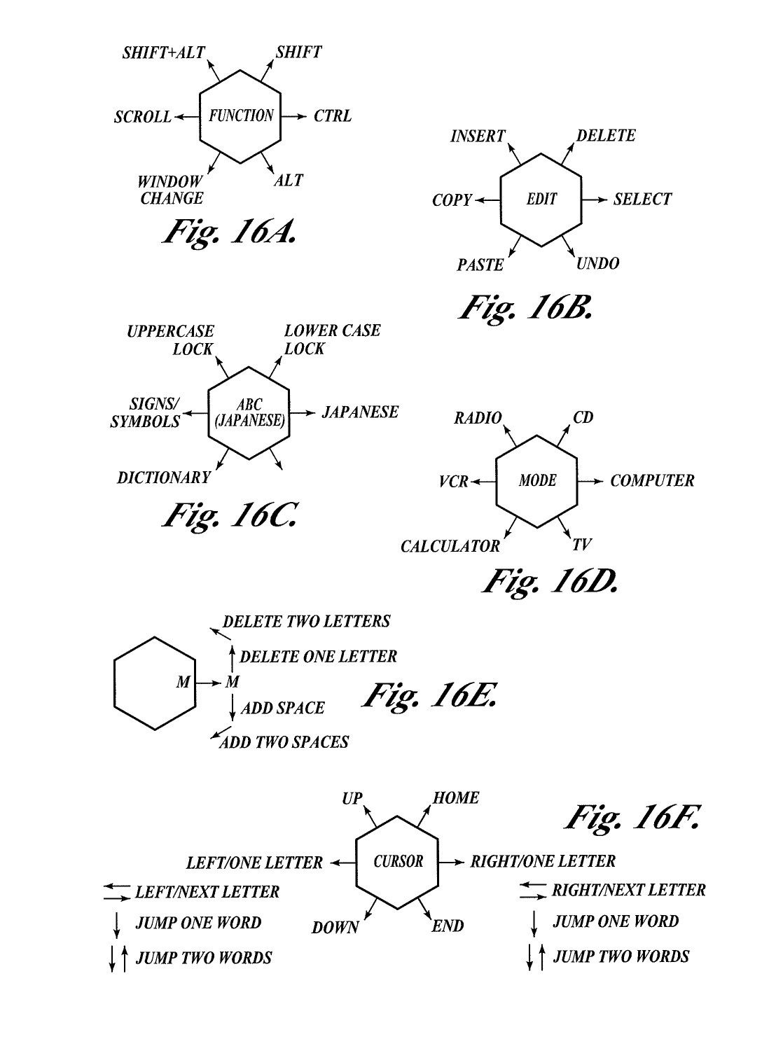

FIG. 14 illustrates a vehicle steering wheel 340 that includes a single keypad 346 similar to the keypad shown in FIG. 3. In this embodiment, the keypad 346 is mounted on a spoke 342 of the steering wheel 340 the outer portion of the spoke 342. The keypad 346 allows a driver to control a greater amount of vehicle systems and accessories without having to remove their hands from the steering wheel 340. The vehicle can also be implemented with a display device, not shown, that works in conjunction with user operation of the keypad 346. In one embodiment, the display device is a heads-up display on the windshield of the vehicle.

FIG. 15 illustrates a personal data assistant 350 that includes a single keypad 354 similar to the keypad shown in FIG. 3. The keypad 354 is mounted below a touch-screen display 352. In an alternate embodiment, the personal data assistant 350 presents a displayed version 356 of the keypad 354 on the display 352. The displayed keypad version 356 is preferably used in conjunction with a stylus 358 or just the user's finger. In order for a user to select an item (character, symbol, function, etc.) assigned to a side of a key of the displayed keypad version 356, the stylus 358 is placed on the desired key and slid in the direction of desired item.

FIGS. 16A-F illustrate various embodiments of actions/functions assigned to key motions. The arrows indicate the motion that the user applies to the keypad and the words next to the arrows describe the associated action or function. The examples illustrated are only a few of numerous possible assignments of action and functions to key motions. The present invention can also be switched to operate in either the first or second modes or with selectable inputs not shown on the keys. For example, as shown in FIG. 16C, the entire keypad can be switched to a Japanese mode of entry, whereby the key motions are now assigned to the entry of Japanese symbols.

In an alternate embodiment, the first mode of operation is activated regardless of whether the X-Y or Z motion is first in a series of motions provided that if a Z motion is first, the following X-Y motion comes within a threshold period of time from the Z motion. Otherwise, if the following X-Y motion does not come within a threshold period of time from the Z motion, the second mode of operation is activated.

In another embodiment, five Japanese vowels are assigned to different keys (similar to the keys described above) and groups of consonants associated with each of the vowels are also associated with the key of the associated vowel or with an adjacent key.

In one embodiment, the arrangement of vowels is assigned to coincide with an English arrangement thus no need to memorize the two sets of key arrangements.

As for English, it is arranged almost alphabetically except vowels. Vowels are arranged so that all of them are assigned the same position within the different keys. This gives a structural base without changing the whole sequence of English alphabet order thus making memorization easier.

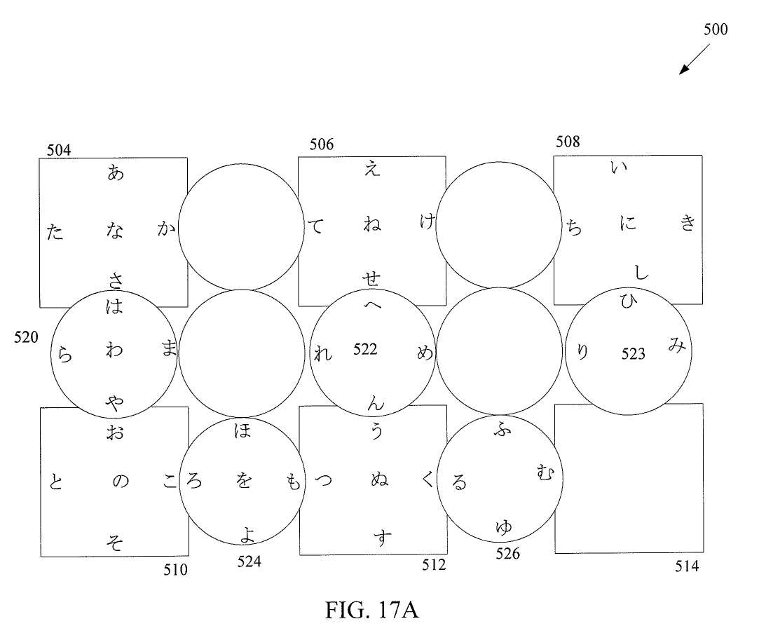

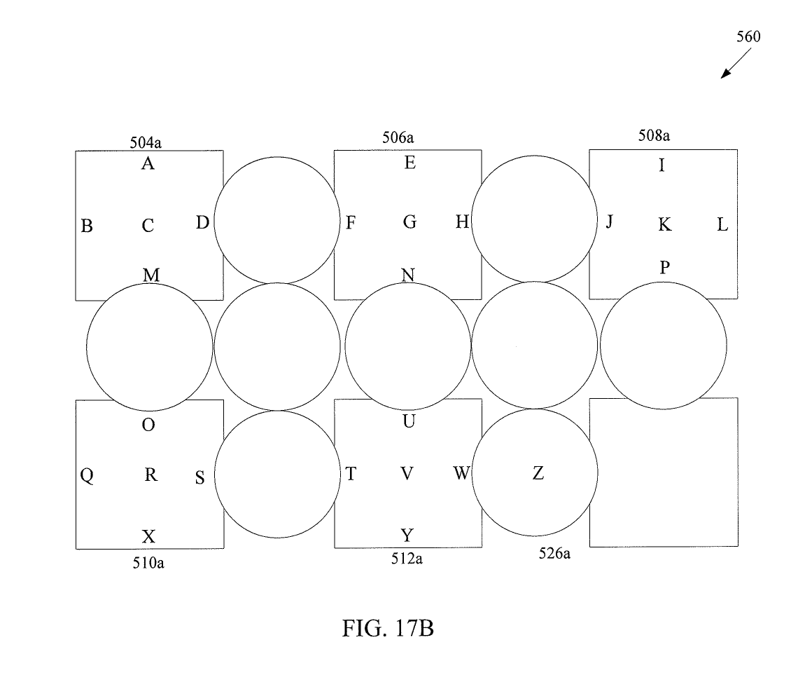

FIG. 17a illustrates a first layout of a keyboard 500. The keyboard 500 includes two rows of three square keys 504-514. The keys 504-514 are constructed in a manner of that described above for either physical keys or keys presented on a touch-screen display. Keys 504-512 include five selectable positions. The first is a top or twelve o'clock position, the second is a nine o'clock position, the third is a center key position, the fourth is a three o'clock position and the last is a bottom or six o'clock position. These positions are relative to an operator of the keyboard 500. In the keyboard 500, the top position for the keys 504-512 are associated with the Kana vowels associated with the vowel sounds “A”, “E”, “I”, “O”, “U”. The table described in the background section shows the Hiragana character that is associated with those vowel sounds. Then, according to the order from top to bottom as shown in the table in the background section the consonant sounds for the associated vowel sound are inserted into the positions within the same key in a clockwise manner finishing up at the center position. For example, the first key 504 has the Hiragana character associated with the Kana vowel sound KA located at the three o'clock position, the character associated with SA located at the six o'clock position, the character associated with TA located at the nine o'clock position and the character associated with NA located at the center position. The following is true for the other keys 506-512. The keyboard 500 also includes secondary keys 520-526. When the keyboard 500 is implemented on a touch screen display, the secondary keys 520-526 are not initially displayed in one embodiment. In another embodiment the secondary keys 520-526 are displayed. Display and selection of characters associated with positions on the secondary keys 520-526 occurs upon simultaneous selection of keys that are adjacent to the secondary keys 520-526. For example, when the user wants to select consonant sounds that are not included in the first key 504, the user activates adjacent keys 504 and 510 thereby causing the system to display the first of the secondary keys 520 when that key isn't initially displayed. If the key 520 is always displayed then the user interacts directly with the key 520. The key 520 includes five positions similar to that of the primary keys 504-512. In this example the characters associated with HA is located at the top position, the character associated with MA is located at the three o'clock position, the character associated with YA is located at the six o'clock position, the character associated with RA is located at the nine o'clock position and the character associated with WA is located at the center position. Selection of the characters associated with positions on the secondary keys 520-526 is performed in the same manner as that for the primary keys 504-526 and that described above in the previous embodiments.

The second of the secondary keys 522 includes the consonant characters associated with the second of the primary keys 506—HE, ME, RE located respectably in the top, three o'clock, and nine o'clock positions. The six o'clock position for the second of the secondary keys 522 is reserved for the last character in the Japanese alphabet. The third key of the secondary keys 523 is associated with the third key 508 of the primary keys. The third key 523 includes the characters associated with HI, MI, RI located respectively at the top, three o'clock and nine o'clock positions.

The fourth key 524 of the secondary keys is located to the right of its associated fourth key 510 of the primary keys. The fourth key 524 is activated upon simultaneous activation of the fourth and fifth keys 510, 512 of the primary keys. The characters included within the fourth key 524 are continuations of the consonant sounds associated with the vowel sound included in the top position of the fourth key 510. These include HO, MO, YO, RO and WO located respectively in the top position, three o'clock, six o'clock, nine o'clock and center positions. A fifth key 526 of the secondary keys includes consonant sounds associated with the vowel sound YU located in the fifth key 512 of the primary keys. Activation of the fifth secondary key 526 occurs when a user simultaneously activates the fifth key 512 and an adjacent sixth key 514. The consonant sounds associated with the fifth key 526 are HU, MU, YU, RU located respectively in the top position, three o'clock, six o'clock and nine o'clock positions.

In one embodiment, the primary keys are of one geometric shape (e.g., square) and the secondary keys are a different geometric shape (e.g., circular). It can be appreciated that other geometric shapes may be used for identifying these keys.

An English language mode keyboard 560 is an alternate embodiment added to that shown in FIG. 17a. Similar to the keyboard 500 shown in FIG. 17a, the English language vowel equivalent to the Hiragana characters shown in FIG. 17a are located at the same locations of the same keys. For example, A, E, I, O and U are located at the top positions of the primary keys 504a, 506a, 508a, 510a, and 512a which correspond in key location respectively to keys 504-512. However, since the English language doesn't include letter equivalents to the consonant sounds in Kana, the distribution of the consonants in the English language mode are as follows. The letters B-L are distributed amongst the nine o'clock center and three o'clock positions of the keys the first three of the primary keys 504a-508a from left to right as viewed by an operator of the keyboard 560. The consonants M, N and P are located in the six o'clock positions of the first three primary keys 504a-508a. The consonants Q, R, S, T, V and W are located in the second row and progress from left to right of the third and fourth primary keys 510a, 512a being distributed amongst the nine o'clock center and three o'clock positions of those keys. X and Y are located in the six o'clock positions of the fourth and fifth primary keys 510a and 512a and the letter Z is either located in the last of the primary keys or is located in a secondary key 526a that is activated by simultaneous selection of adjacent primary keys.

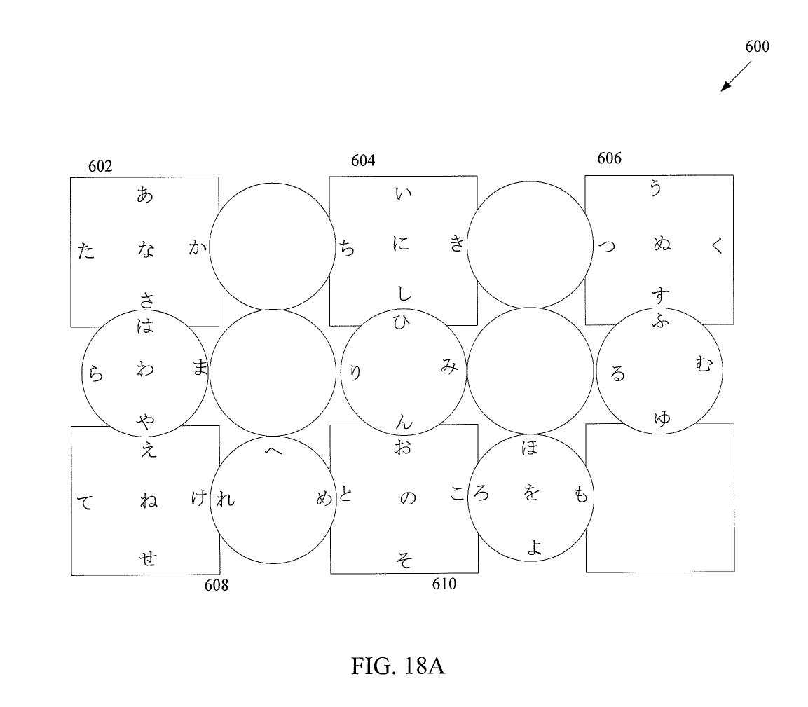

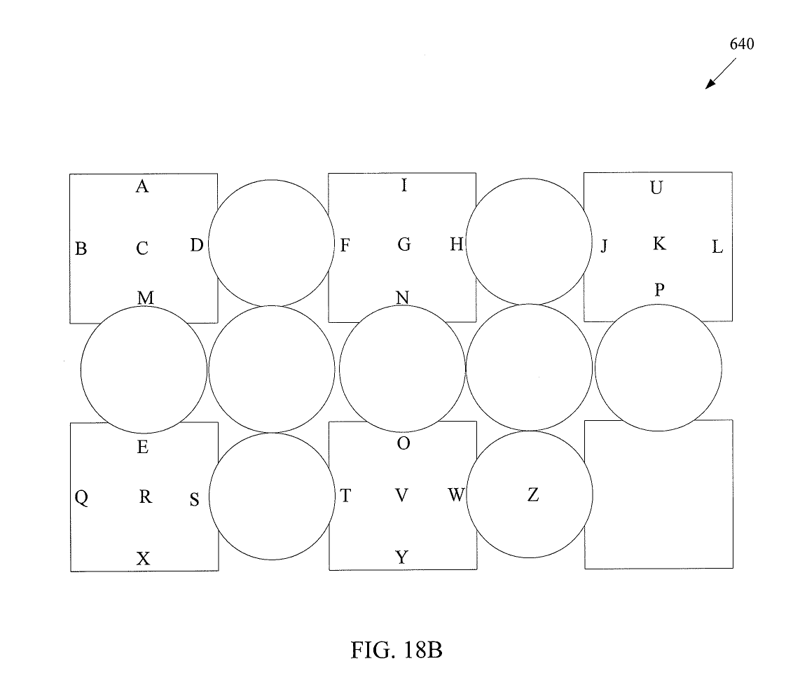

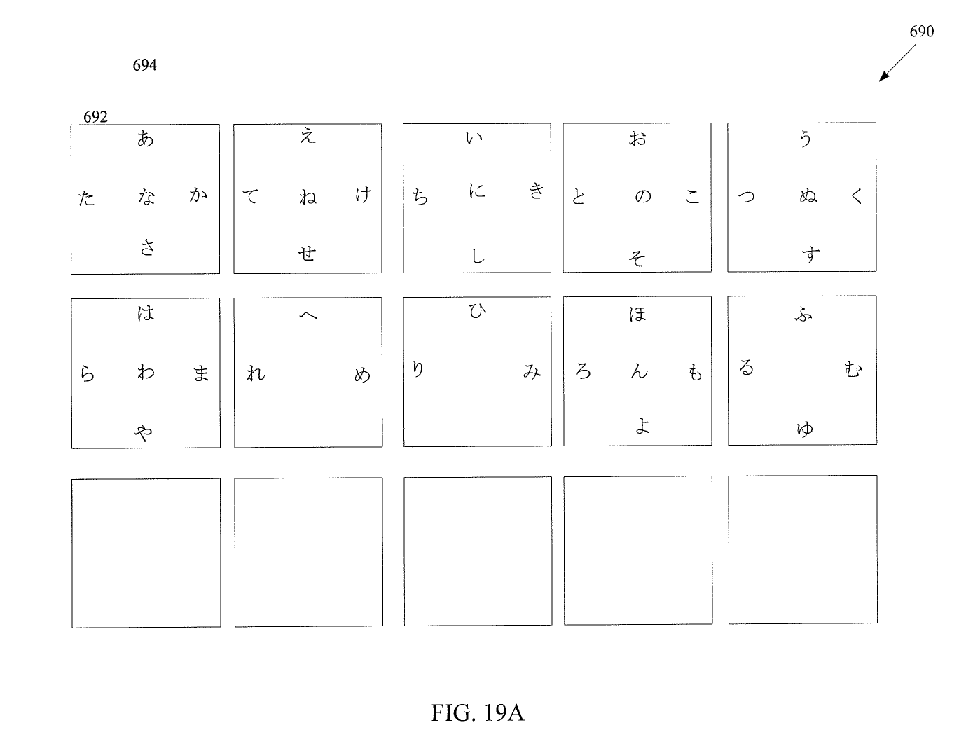

FIG. 18a illustrates an alternate embodiment of the display of the keyboard 500 shown in FIG. 17a. The keyboard 600 is ordered in a similar manner as keyboard 500 except that the order of the vowels is different. The primary keys 602-610 are ordered with the vowels in the top position as follows: A, I, U, E, O. Also, the consonant sounds associated with those vowel sounds are included in the same key in a similar manner as that in the keyboard 500. Also, the secondary keys are positioned adjacent to the key having their associated vowel sound. For example, the second key 604 includes all of the I consonant sounds KI, SI, TI, NI and the secondary key located below it includes the rest HI, MI and RI with the last letter of the Japanese alphabet located at the six o'clock position.

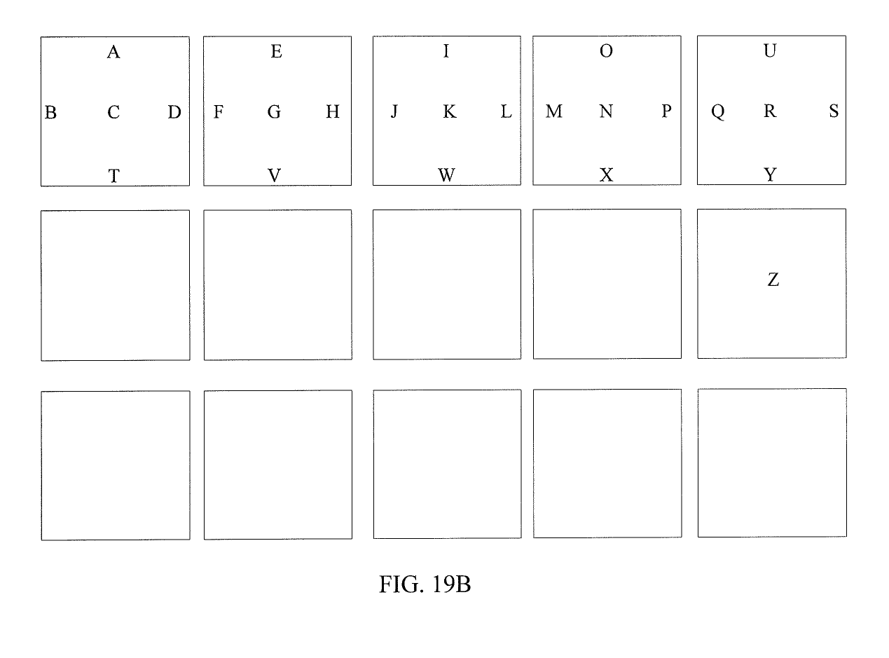

FIG. 18b is an English language mode version to be combined with the keyboard 600 shown in FIG. 18a. The only thing that has been altered in the keyboard 640 in comparison to the keyboard 560 shown in FIG. 17b is that the vowels at the top position of the primary keys are changed in order to be in comparable positions to the similar vowel sound in the Japanese mode keyboard 600 shown in FIG. 18a. FIGS. 19a and 19b are keyboards 690 having five columns of keys. Each of the columns is associated with a vowel. The first row of keys is comparable to the primary keys shown in FIG. 17a. The second row of keys in the keyboard 690 is comparable to the secondary keys shown in FIG. 17a. So for example, the first column has the first row key 694 having the Hiragana characters in the following clockwise order on the key 692—A, KA, SA, TA and NA located in the center position of the key 692. The key in the second row of the first column 694 is similar to the secondary key 520 shown in FIG. 17a in that the Hiragana characters associated with the consonant sounds HA, MA, YA, RA, WA are positioned the same as that shown in the secondary key 520.

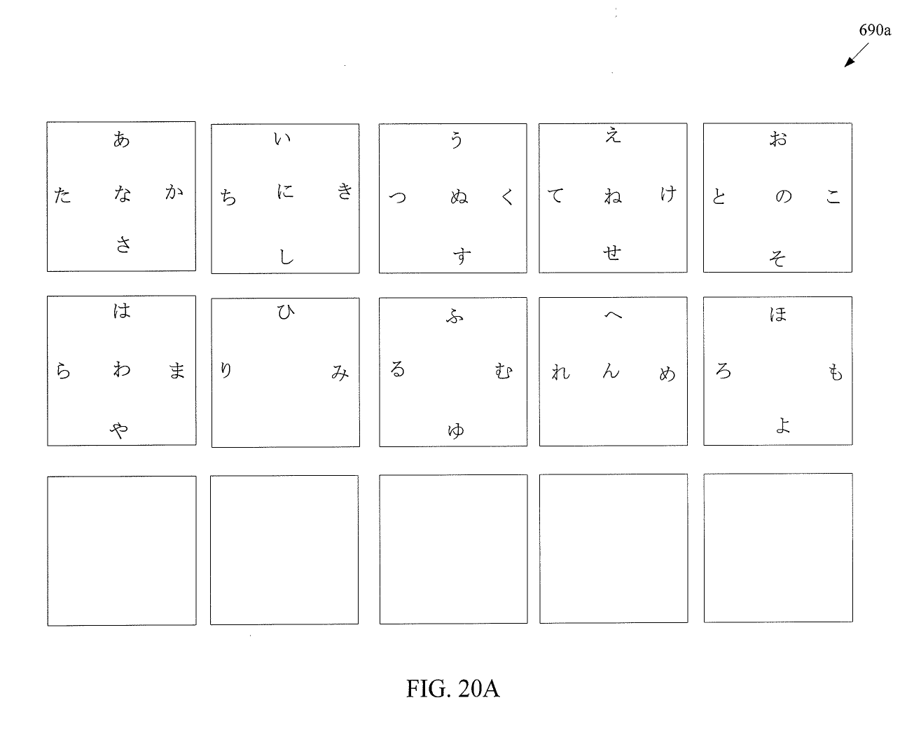

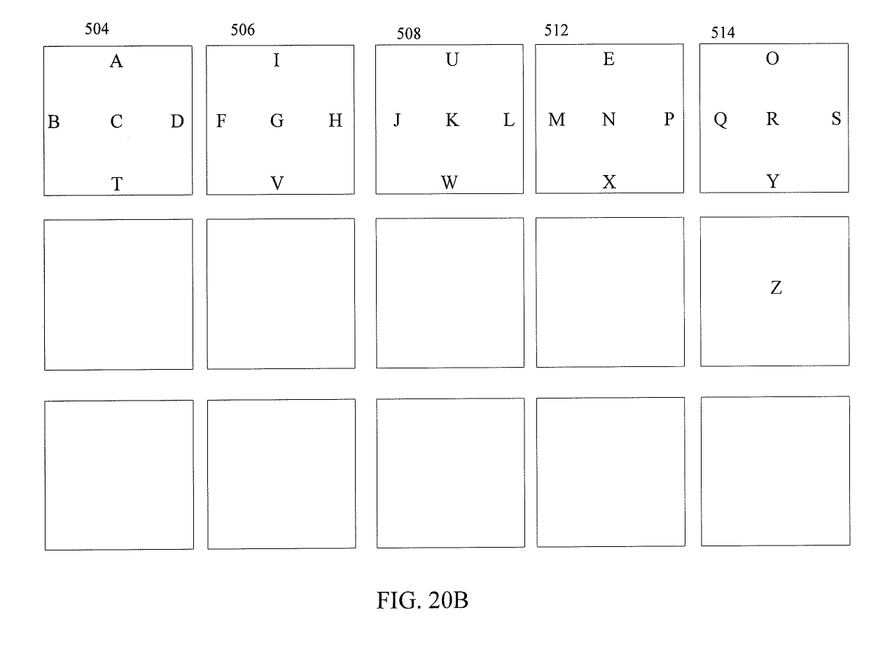

FIGS. 20a (keyboard 690a) and 20b are Japanese and English mode keyboards in a similar three row five column structure as that shown in FIGS. 19a and b except that the Hiragana characters are distributed in a similar manner as that in FIG. 18a with the first row being associated with vowels in the order A, I, U, E, O and the second row including the additional consonants that are associated with the vowel sound in the respective column.

While the preferred embodiment of the invention has been illustrated and described, as noted above, many changes can be made without departing from the spirit and scope of the invention. For example, other languages than those shown above can be used. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A keyboard operable in at least an English language mode and a Japanese language mode, the keyboard comprising:
a plurality of keys, at least 5 keys being associated with a plurality of letters in the English language mode and a plurality of characters in the Japanese language mode,
wherein the plurality of characters in the Japanese language mode comprise Hiragana characters,
wherein each of the at least 5 keys comprises the following positions relative to sitting position of a user of the keyboard:
a first position located at 12 o'clock;
a second position located at 9 o'clock;
a third position located at a center of key location;
a fourth position located at 3 o'clock; and
a fifth position located at 6 o'clock,
wherein the first position each of the at least 5 keys is associated with one of A, E, I, O, U in the English language mode and one of [symbol] in the Japanese language mode,
wherein a letter or character associated with one of the positions is selected for display when a user activates the respective key and performs at least one of a movement of the key in the direction of the position or no movement for the third position.

2. The keyboard of claim 1, wherein the order of letters and characters assigned to positions second through fifth for the first through fifth of the at least 5 keys are as follows:
for the English language mode:
B, C, D, M, F, G, H, N, J, K, L, P, Q, R, S, X, T, V, W, Y; and
for the Japanese language mode:

[symbol]

[symbol]

[symbol]

3. The keyboard of claim 2, wherein the first position of a first one of the at least 5 keys is associated with both A and [symbol] in the respective mode, the first position of a second one of the at least 5 keys is associated with both E and [symbol] in the respective mode, the first position of a third one of the at least 5 keys is associated with both I and [symbol] in the respective mode, the first position of a fourth one of the at least 5 keys is associated with both O and [symbol] in the respective mode, and the first position of a fifth one of the at least 5 keys is associated with both U and [symbol] in the respective mode.

4. The keyboard of claim 3, wherein the first through third keys of the at least 5 keys are located in a top row and the fourth and fifth keys are located in a bottom row, the bottom row being closer to a user than the top row.

5. The keyboard of claim 4, further comprising a plurality of secondary keys being activated when the user activates adjacent pairs of the plurality of keys.

6. The keyboard of claim 5, wherein first and second ones of the secondary keys comprise the following positions relative to a user of the keyboard:
a first position located at a 12 o'clock;
a second position located at 9 o'clock;
a third position located at a center of key location;
a fourth position located at 3 o'clock; and
a fifth position located at 6 o'clock,
wherein the order of characters assigned to the first through fifth positions for the first then the second ones of the secondary keys for the Japanese language mode are as follows: [symbol] [symbol]
wherein third and fourth ones of the secondary keys comprise the following positions relative to a user of the keyboard:
a first position located at 12 o'clock;
a second position located at 9 o'clock;
a third position located at 3 o'clock; and
a fourth position located at 6 o'clock,
wherein the order of characters assigned to the first through fourth positions for the third then the fourth ones of the secondary keys for the Japanese language mode are as follows: [symbol]
wherein a fifth one of the secondary keys comprise the following positions relative to a user of the keyboard:
a first position located at 12 o'clock;
a second position located at 9 o'clock; and
a third position located at 3 o'clock,
wherein the order of characters assigned to first through third positions for the fifth one of the secondary keys for the Japanese language mode is as follows:

[symbol]

7. The keyboard of claim 6, wherein the first one of the secondary keys is accessed upon simultaneous activation of the first and the fourth of the at least 5 keys, the second one of the secondary keys is accessed upon simultaneous activation of the fourth and the fifth of the at least 5 keys, the third one of the secondary keys is accessed upon simultaneous activation of the second and fifth of the at least 5 keys, the fourth one of the secondary keys is accessed upon simultaneous activation of the fifth of the at least 5 keys and an additional key, and the fifth one of the secondary keys is accessed upon simultaneous activation of the third of the at least 5 keys and the additional key.

8. The keyboard of claim 3, wherein the first through fifth keys of the at least 5 keys are located in a top row, further comprising a bottom row of keys, the bottom row being closer to a user than the top row.

9. The keyboard of claim 8, wherein the keys in the bottom row comprise:
first and second keys comprise the following positions relative to a user of the keyboard:
a first position located at 12 o'clock;
a second position located at 9 o'clock;
a third position located at a center of key location;
a fourth position located at 3 o'clock; and
a fifth position located at 6 o'clock,
wherein the order of characters assigned to first through fifth positions for the first then the second keys of the bottom row for the Japanese language mode are as follows: [symbol] [symbol]
a third key comprises the following positions relative to a user of the keyboard:
a first position located at 12 o'clock;
a second position located at 9 o'clock;
a third position located at 3 o'clock; and
a fourth position located at 6 o'clock,
wherein the order of characters assigned to the first through fourth positions for the third key of the bottom row for the Japanese language mode are as follows: [symbol]
fourth and fifth keys comprise the following positions relative to a user of the key board:
a first position located at 12 o'clock;
a second position located at 9 o'clock; and
a third position located at 3 o'clock,
wherein the order of characters assigned to first through third positions for the fourth then the fifth keys of the bottom row for the Japanese language mode is as follows:

[symbol]

10. The keyboard of claim 9, wherein the first key of the bottom row is located below the first one of the at least 5 keys, the second key of the bottom row is located below the fourth one of the at least 5 keys, the third key of the bottom row is located below the fifth one of the at least 5 keys, the fourth key of the bottom row is located below the second one of the at least 5 keys, and the fifth key of the bottom row is located below the third one of the at least 5 keys.

11. The keyboard of claim 1, wherein the order of letters and characters assigned to positions second through fifth for the first through fifth ones of the at least 5 keys are as follows:
for the English language mode:
B, C, D, M, F, G, H, N, J, K, L, P, Q, R, S, X, T, V, W, Y;
for the Japanese language mode:

[symbol]

[symbol]

[symbol]

12. The keyboard of claim 11, wherein the first position of one of the at least 5 keys is associated with both A and [symbol] in the respective mode, the first position of a second one of the at least 5 keys is associated with both I and [symbol] in the respective mode, the first position of a third one of the at least 5 keys is associated with both U and [symbol] in the respective mode, the first position of a fourth one of the at least 5 keys is associated with both E and [symbol] in the respective mode, and the first position of a fifth one of the at least 5 keys is associated with both O and in [symbol] the respective mode.

13. The keyboard of claim 12, wherein the first through third keys of the at least 5 keys are located in a top row and the fourth and fifth keys are located in a bottom row, the bottom row being closer to a user than the top row.

14. The keyboard of claim 13, further comprising a plurality of secondary keys being activated when the user activates adjacent pairs of the plurality of keys.

15. The keyboard of claim 14, wherein first and second ones of the secondary keys comprise the following positions relative to a user of the keyboard:
a first position located at 12 o'clock;
a second position located at 9 o'clock;
a third position located at a center of key location;
a fourth position located at 3 o'clock; and
a fifth position located at 6 o'clock,
wherein the order of characters assigned to the first through fifth positions for the first then the second ones of the secondary keys for the Japanese language mode are as follows: [symbol] [symbol]
wherein third and fourth ones of the secondary keys comprise the following positions relative to a user of the keyboard:
a first position located at 12 o'clock;
a second position located at 9 o'clock;
a third position located at 3 o'clock; and
a fourth position located at 6 o'clock,
wherein the order of characters assigned to the first through fourth positions for the third then the fourth ones of the secondary keys for the Japanese language mode are as follows: [symbol]
wherein a fifth one of the secondary keys comprises the following positions relative to a user of the keyboard:
a first position located at 12 o'clock;
a second position located at 9 o'clock; and
a third position located at 3 o'clock,
wherein the order of characters assigned to first through third positions for the fifth one of the secondary keys for the Japanese language mode is as follows:

[symbol]

16. The keyboard of claim 15, wherein the first one of the secondary keys is accessed upon simultaneous activation of the first and the fourth of the at least 5 keys, the second one of the secondary keys is accessed upon simultaneous activation of the fifth of the at least 5 keys and an additional key, the third one of the secondary keys is accessed upon simultaneous activation of the second and fifth of the at least 5 keys, the fourth one of the secondary keys is accessed upon simultaneous activation of the third of the at least 5 keys and the additional key, and the fifth one of the secondary keys is accessed upon simultaneous activation of the fourth and fifth of the at least 5 keys.

17. The keyboard of claim 12, wherein the first through fifth keys of the at least 5 keys are located in a top row, further comprising a bottom row of keys, the bottom row being closer to a user than the top row.

18. The keyboard of claim 17, wherein the keys in the bottom row comprise:
a first key has the'following positions relative to a user of the keyboard:
a first position located at 12 o'clock;
a second position located at 9 o'clock;
a third position located at a center of key location;
a fourth position located at 3 o'clock; and
a fifth position located at 6 o'clock,
wherein the order of characters assigned to first through fifth positions for the first key of the bottom row for the Japanese language mode are as follows: [symbol]
second and third keys comprise the following positions relative to a user of the keyboard:
a first position located at 12 o'clock;
a second position located at 9 o'clock;
a third position located at 3 o'clock; and
a fourth position located at 6 o'clock,
wherein the order of characters assigned to the first through fourth positions for the second then third keys of the bottom row for the Japanese language mode are as follows: [symbol]
a fourth key comprises the following positions relative to a user of the keyboard:
a first position located at 12 o'clock;
a second position located at 9 o'clock; and
a third position located at 3 o'clock,
wherein the order of characters assigned to first through third positions for the fourth key of the bottom row for the Japanese language mode is as follows: [symbol]
a fifth key comprises the following positions relative to a user of the keyboard:
a first position located at 12 o'clock;
a second position located at 9 o'clock;
a third position located at 3 o'clock; and
a fourth position located at a center of key location,
wherein the order of characters assigned to first through fourth positions for the fifth key of the bottom row for the Japanese language mode is as follows:

[symbol]

19. The keyboard of claim 18, wherein the first key of the second row is located below the first one of the at least 5 keys, the second key of the second row is located below the third one of the at least 5 keys, the third key of the second row is located below the fifth one of the at least 5 keys, the fourth key of the second row is located below the second one of the at least 5 keys, and the fifth key of the second row is located below the fourth one of the at least 5 keys.
